(19) United States
(12) Patent Application Publication
(10) Pub. No.: US 2008/0208571 A1
(43) Pub. Date: Aug. 28, 2008

(54) Maximum-Likelihood Universal Speech Iconic Coding-Decoding System (MUSICS)

(76) Inventor: Ashok Kumar Sinha, Ypsilanti, MI (US)

Correspondence Address: ASHOK K. SINHA;MULTI-CONSULTING SERVICES, 4837 SHELLBARK DRIVE, YPSILANTI, MI, 48197-6897, US

(21) Appl. No.: 11/942,708

(22) Filed: Nov. 19, 2007

Related U.S. Application Data
(60) Provisional application No. 60/860,144, filed on Nov. 20, 2006.

(51) Int. Cl. G10L 19/00

(52) U.S. Cl. 704/203

(57) ABSTRACT

This application for patent describes an invention toward achieving potentially hundred- to thousand-fold enhancement in the efficiency of the utilization of frequency-bandwidth for digital transmission of speech. This invention is based on the observation that human speech can be assumed to be composed of a series of contiguous fundamental ‘phonic elements’ (“phonoms”) that could be judiciously used toward developing an extremely low bit-rate digital coding of the speech signals. A generic example of a simple implementation of this invention—the basic equipment and associated device(s), methodologies and technologies—for ultr-low bit-rate voice-telecommunications over any transmission channel is also presented. The present invention is universally applicable to any language of the world, and to voice-telecommunications employing various media and service-applications including, but not limited to, land-line copper-wire networks, satellite telephony, satellite radio, fiber-optical cables, terrestrial wireless, voice over Internet Protocols (VoIP), and similar media and services.

### REFERENCE

PROVISIONAL APPLICATION No. 60/860,144 Dated 20 Nov. 2006

Human speech can be assumed to be composed (in the time-domain) of a series of contiguous basic or fundamental elements which cannot be further decomposed, such as a basic syllable. Here, these basic sounds constituting—that is, acting as the building blocks of—all types (in any language of the world) of human speech are termed ‘phonic elements’ or ‘phonoms’ for short (in analogy with the atoms in the Periodic Table in Chemistry, as the basic building blocks of all material substance found in nature.} This invention presents an example of a set of phonoms that could be used toward a very low bit-rate digital coding of human speech, thereby providing many thousand percent enhancement in the efficiency of the utilization of the frequency bandwidth. Since available bandwidth is obviously a limited resource, while its demand has been continually increasing under burgeoning volume, methodology and technologies of voice-telecommunications all over the world, the present invention, applicable to any language of the world, can be implemented toward achieving a great degree of enhancement in the efficiency of the utilization of frequency bandwidth for transmission of speech and voice-telecommunications employing various media and service applications including, but not limited to, land-line copper-wire networks, satellite telephony, satellite radio, fiber-optical cables, terrestrial wireless, voice over Internet Protocols (VoIP), etc. The following Sections of this Application for a patent for this invention, referred to as the Maximum-Likelihood Universal Iconic Coding-Decoding Systems (MUSICS), describe the basic concept as well as the generic techniques for the enablement and commercial implementation thereof.

### 1. FIELD AND SUMMARY OF THE INVENTION

The present invention relates to transmission of human speech signal over any medium and for any service application (land-line telephony, satellite telephony, satellite radio, fiber-optical transmission over land or under ocean, terrestrial wireless, etc.) utilizing a very low bit-rate (of the order of only a few hundred bit/second) and, concordantly, a very small bandwidth, compared to the conventional techniques (typically using a few kbit/sec). The method adopted in the present invention is applicable universally to speech in any language of the world. This is based on the important recognition, embodied in this invention, that human speech (in any language) is ultimately composed of a relatively small number (approximately 500) of elementary syllabic sound components, just as myriad of substances of all matter in the universe is ultimately composed of only a small number (about 100) of basic atomic elements. The basic or elementary sounds are termed ‘phonic elements in this Application. Further, the bit reduction method in this invention is based on processing of the phonic elements in the frequency domain, unlike the case of the conventional methods of time-domain analysis and digital processing and associated bit-reduction. In particular, this invention includes the design and utilization of a Standard Reference Iconic Template (SRIT) as a stored data-base on the receive side. The SRIT comprises a set of standard bit sequences (SBSs), each SBS representing the frequency-domain representation of one particular phonic element.

In summary, MUSICS is a digital coder-decoder (Codec), universally applicable to any language in the world, and operating at an ultra-low bit-rate (a few 100 bit/sec, typically, less than 1 kbit/sec); thereby enhancing the capacity of a speech telecommunications channel (by a factor of hundreds or even thousands) as compared with a conventional analog or digital speech codec.

### 2. DESCRIPTION OF THE PRIOR ART

The problem of speech signal processing including compression and optimization of the utilization of the baseband and carrier spectrum has been actively considered for decades. A large number of related techniques developed and commercially implemented. Both analog and digital signals and processing schemes including Predictive Coding, Syllabic Companding, Pulse Code Modulation (PCM), differential coding, Delta Modulation (DM), etc., have been employed for this purpose. However, these techniques have been conventionally confined to analysis and processing of the speech signal in the time domain. References in open literature of technical and professional journals as well as in the number of patents in this area are too numerous to be cited here; and are generally well-known to one versed in the art.

To the knowledge of this author, little attention has been paid to development of theoretical or commercial methods that perform signal processing of the speech signal in the frequency domain, or that are based on the fact that human speech could be considered as composed of a relatively small number of phonic elements (different elementary sounds). Thus, use of these two characteristics, viz.,

(i) A small number of elementary sounds (‘phonic elements’) as the basic constituents of al types of human speech, in various languages of the world; and

(ii) Frequency-domain analysis and processing including digital representation of the phonic elements;

are considered and incorporated in this invention as the means for achieving very low bit-rate coding, transmission and decoding of the speech signal in a universal manner, applicable to any language of the world. This novel approach allows speech signal coding-decoding using a very low bit-rate (of the order of only a few hundred bit/sec), thereby a very high degree of bandwidth compression and associated efficiency and economy in the utilization of the allocated spectrum. Many hundred-fold gain the channel capacity could thus be achievable with the implementation of the method and related equipment comprised by this invention. No direct reference or prior art in connection with this invention is deemed available, however, for the stated reason.

### 3. BRIEF DESCRIPTION OF THE SYSTEM COMPONENTS AND DRAWINGS

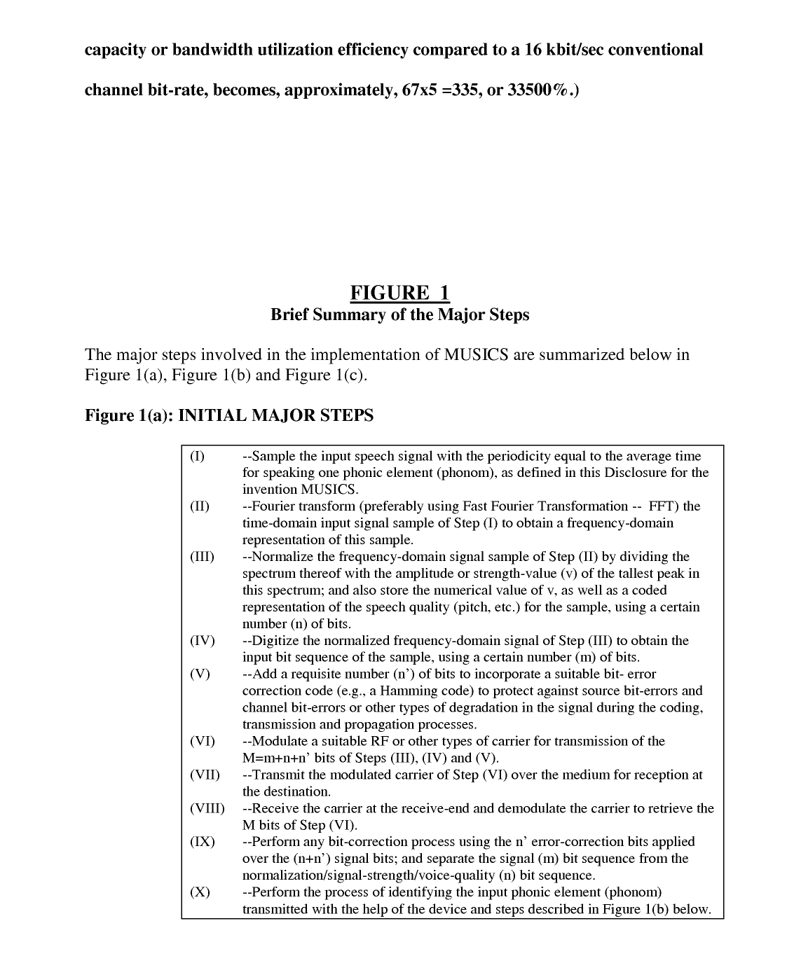

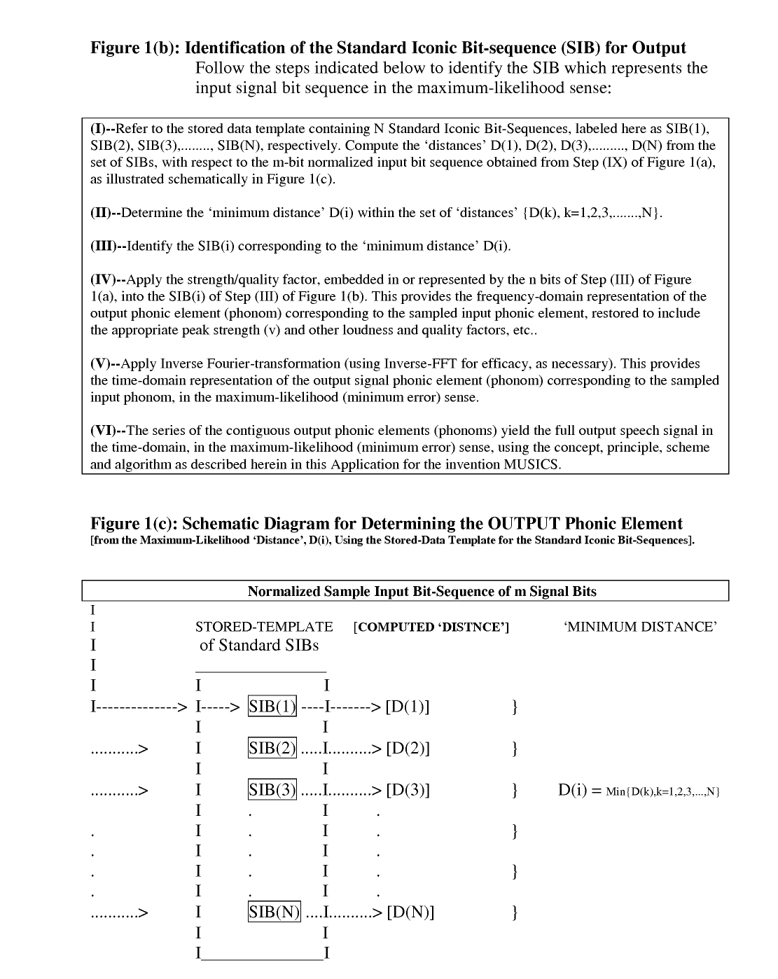

An overview of the MUSICS is schematically shown in the flow-diagram of FIG. 1, which attempts to encapsulate the main steps and processing involved in a self-explanatory fashion.

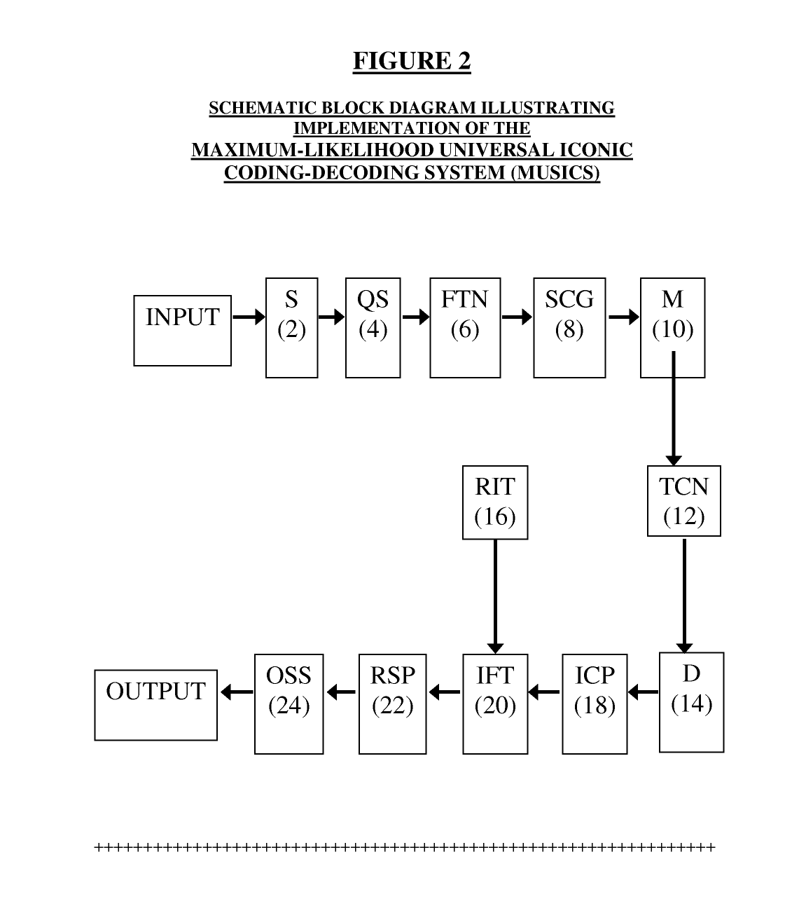

The major constituents of this invention are briefly described schematically in the block diagram of FIG. 2, and briefly summarized below. The following description thus also summarizes the essential steps for the enablement and implementation of this invention (MUSICS). Note that the serial numbers within the parenthesis ( ) in the following description of FIG. 2 refer to the serial numbers shown in corresponding components in FIG. 2.

### (2) The Audio Source (S):

This is base-band speech signal in any language, comprising the system input, and provided by a voice source, such as telephone, microphone, or a similar device.

### (4) Quantum Sampler (QS):

This samples the speech signal with a fixed periodicity (though the actual value of this fixed frequency of sampling frequency could be made adjustable in an implementation of the invention) or time-period (typically, 0.1 to 0.5 seconds, as required on the basis of the audio-features of the specific language, the systems performance level desired and other commercial considerations, etc.) involved, corresponding to the mean time for one phonic element of speech.

### (6) Fast-Fourier Transformer and Normalizer (FTN):

This produces a Fast-Fourier Transform (FFT) of the sampled signal. The value, v, of the highest peak in the frequency domain spectrum thus produced is noted, and then a Normalized spectral representation is generated by dividing the whole spectral distribution by this highest level (v). Thus the normalized spectrum has the highest peak value equal to unity (1.0) while the remaining spectral components have relative values (<1.0) referred to this peak value as unity.

### (8) Syllabic Code Generator (SCG) for Phonic Elements:

This digitizes the normalized spectrum output of the FTN, producing a small bit sequence, m (typically no more than 9 bits). The highest peak value, v, is also digitized with a selected resolution and hence using a certain number, n, of bits (typically no more than 7 bits corresponding to 128 gradations.) The input bit-stream comprising the m-bits and the n-bits (typically no more than 9+7=16 bits) may now be optionally augmented with a set of error correction bits using a suitable source-coding and channel error correction coding scheme, if desired or needed, to protect the generated signal (m+n) bits against any possible bit-error; we assume a suitable coding with a maximum number, n′, of error correction bits (typically n′=8 bits.) The total number of bits to be transmitted for the coded signal consists of (m+n+n′) bits (typically no more than 9+7+8=24 bits.)

### (10) Modulator (M):

This modulates a suitable carrier wave with the bit-streams representing

(a) the maximum or peak value of the spectrum (v),
(b) the normalized spectral distribution, for each phonic element (m), and
(c) coding bits (n′)
(as mentioned above, a total of 24 bits are expected to more than suffice for all three components involved). This bit-stream is referred to as the original signal, s, to be transmitted for each phonic element of the base-band voice signal.

### (12) Transmission Channel for the Network (TCN):

This represents the transmission channel involved and could include terrestrial wireless, satellite network, optical fiber, etc., or a combination thereof. The pertinent service application could include satellite telephony, satellite radio, terrestrial telephony using undersea or landline fiber-optical cables or conventional wire networks for fixed or mobile (terrestrial wireless, aeronautical/maritime satellite mobile telecommunications services), and so on. These and all similar other services and applications are assumed to be included as potential users of this invention.

### (14) Demodulator (D):

This demodulates the received signal by stripping the carrier wave to yield a bit-stream, s′, corresponding to the transmitted signal, s.

### (16) Reference Iconic Template (RIT):

This stores a set of Standard Iconic Bit-sequences (SIB), S1, S2 . . . , SN, in a suitable format. The ith bit-sequence, Si, represents the Normalized bit representation of the ith Standard syllable possible in a human speech, irrespective of the language used; (i=1, 2, . . . , N). It is postulated here that it should be possible to identify, find or develop such a set for a reasonably small value of N, the total number of Standard Iconic Bit-sequences (SIBs) in the set. A typical choice for the value of N may be a few hundred, up to a maximum value (for example, typically N<500). One suitable set of SIBs with N<500 has been already identified as part of this invention and can be made available for actual implementation; although different designs and implementations with N as a parameter to be determined based on the specific linguistic features and performance levels, etc., could generally be considered for the implementation of this invention.

### (18) Icon Comparator and Processer (ICP):

This decodes the received bit-stream to separate the coding bits and then to extract the bits representing the peak spectral value for the phonic element (v), and the bits corresponding to the base-band syllabic input signal, which are labeled here (on the receive side) as m-bits. The numerical value corresponding to v is retrieved. Also, the bit sequence m is compared with each of the N Standard Iconic Bit-sequence (SIBs) from the Reference Iconic Template (RIT), in order to identify the Standard Reference Bit-sequence, Sj, which best matches with the sequence s′. This bit sequence matching could be most simply performed on the basis of the minimum Hamming distance between the two bit sequences, or any other suitable digital decoding technique could be implemented in actual practice. The bit sequence, Sj, thus is taken as the maximum-likelihood representation of the received sequence, s′.

### (20) Inverse FFT (IFT):

It should be noted that each SIB is associated with a normalized standard spectral representation of a particular (known) syllable (irrespective of the language involved. Multiplying this spectral representation of the selected SIB, Sj, with the peak-value (the received value corresponding to v, the most dominant frequency component in the FFT of the transmitted signal bit sequence, m, for the syllable in question), the frequency-domain representation of the transmitted signal, m, on the receive-side (in the maximum-likelihood, or minimum-error, sense) is obtained. By performing an Inverse FFT (IFFT) for the receive spectral distribution, the best possible representation of the syllable transmitted from the Source, S, is obtained by this system component (IFT.)

### (22) Receive Signal Processor (RSP):

This recreates the transmitted syllable for audio using the output of IFT and performing any additional processing for high-fidelity, as appropriate.

### (24) Output for the Speech Signal (OSS):

For a series of input syllables juxtaposed in certain order comprising the input speech signal, S, OSS finally produces the output, S′, the output speech comprising the processed syllables juxtaposed in the same order. As speech in any language is in fact a properly juxtaposed series of syllables, the above process and its implementation in a suitable system thus reproduces input speech signal at the output, using a very small bit-rate (typically much less than 1 kbit/sec) with high fidelity, for any language of human speech in the world

What is claimed is:

1. A STANDARD OR REFERENCE “PHONOM” SET GENERATOR (SRPSG), comprising a reference set of phonic elements means, called ‘phonoms’ in this Application (in majority of cases, these phonic elements may be simply the basic syllables involved), for developing, finding and/or identifying a set of basic voice phonetic components in human speech, pertinent to the spoken language of the speaker, or a family of languages spoken by speakers of a community or country.

2. A reference set of phonic elements (phonoms) means for developing, finding and/or identifying a set of basic voice phonetic components in human speech, as claimed in claim 1, but independent of the specific language used;

3. A bit generation scheme means for generating a set of non-identical bit sequences, each a certain number (m) of bits long, so as to assign each bit sequence of the said bit sequence set to one particular phonic element (phonom) as claimed in claim 1 and claim 2.

4. A template means of the reference bit sequence, used as a stored data software and/or hardware device or means for storing the set of bit sequences representing the set of phonoms as claimed in claim 1 and claim 2, serving as the reference or Standard Iconic Bit-sequences (SIBs), one generic example of such a set having been identified by the present Inventor and the associated details being included in Appendix A of this Disclosure for the present Invention (MUSICS).

5. Means for formulating and defining SIBs and software and/or hardware means for developing and designing templates as claimed in claim 4 and other related or similar schemes, systems and devices.

6. A COMPARATOR comprising a software and/or hardware means for accessing and exiting the SRPSG as claimed in claim 1 through claim 5 for comparing an input bit sequence with each member of the SIBs as claimed in claim 4 in order to determine the difference by computing the ‘distance’ of the input bit sequence with respect to each member of the set comprising the SIBs.

7. A software and/or hardware or a hybrid design and device for determining the least ‘or minimum ’ distance’ among the set of ‘distances’ as claimed in claim 6, and software and/or hardware device for identifying the particular SIB and the corresponding phonom, as claimed in claim 1 through claim 5.

8. AN ULTRA-LOW-BIT-RATE VOICE CODER, comprising a speech or voice coder means for human speech digital coding with ultra-low bit-rates based on the above or a similar scheme, and providing a STANDARD or REFERENCE SYLLABLE SET GENERATOR, as described in claim 1 through claim 5.

9. AN ULTRA-LOW-BIT-RATE VOICE DECODER, comprising a speech or voice decoder means for human speech decoding with ultra-low bit-rates based on a Standard or Reference Syllable Set Generator, as claimed in claim 1 through claim 5, and operating with a compatible coder as claimed in claim 8.

10. A SPEECH PROCESSOR SYSTEM OPERATING ON THE PRINCIPLE OF SRPSG as described in claim 1 through claim 9 described above, and associated digital, analog or hybrid coding-decoding devices (codecs) and digital, analog or hybrid Comparators devices.

11. A MAXIMUM-LIKELIHOOD UNIVERSAL SPEECH ICONIC CODING-DECODING SYSTEM (MUSICS) utilizing the principle of the maximum-likelihood for the coding-decoding processes for voice transmission over any medium and for any service application (land-line telephony, satellite telephony, satellite radio, fiber-optical cable, terrestrial wireless, and similar other media, services, applications, and systems), and independent of the specific language involved, as exemplified under claims 1 through claim 10, including variations embodying alternative implementations or types of devices performing phonic element (phonom) or syllable-based processing and transmission of human speech at a very-low bit-rates (typically <1 kbit/sec), as described in this Application for Patent for the present Invention, generically called the ‘Maximum-likelihood Universal Speech Iconic Coding-Decoding Systems (MUSICS.)
